(19) United States
(12) Patent Application Publication
(10) Pub. No.: US 2014/0053567 A1
(43) Pub. Date: Feb. 27, 2014

(54) SYSTEM AND METHOD FOR CONTROLLING A GAS TURBINE ENGINE GENERATOR SET

(71) Applicant: Fritz Langenbacher, San Diego, CA (US)

(72) Inventor: Fritz Langenbacher, San Diego, CA (US)

(21) Appl. No.: 13/592,253

(22) Filed: Aug. 22, 2012

(51) Int. Cl. F02C 9/00; F02C 9/48; F02C 9/26

(52) U.S. Cl. 60/773; 60/39.24; 60/39.281

(57) ABSTRACT

A method for controlling a turbine engine generator set is disclosed. The method comprises: sensing an operating parameter indicative of a load increase on the turbine engine generator set; operating the turbine engine generator set in a first mode when the sensed operating parameter is within a predetermined range; and operating the turbine engine generator set in a second mode when the sensed operating parameter is outside the predetermined range. The second mode provides a rate of adjustment of operation of the turbine engine generator set that is greater than a rate of adjustment during the first mode.

### TECHNICAL FIELD

The present disclosure relates generally to a system and method for controlling a gas turbine engine generator set.

### BACKGROUND

Gas turbine engine generator sets are often used in industrial systems, such as heating, cooling, food processing, etc., and provide electrical power for consumption by electrical equipment, such as electric motors or lighting systems. Depending on the operation of driven equipment, the electrical power drawn from a generator set often varies, thereby changing the electrical load of the generator set.

U.S. Pat. No. 4,380,894 discloses a fuel supply control system for a turbine engine. The system determines a fuel flow demand based a speed of a compressor shaft and an engine load. When the load applied to the engine is increased, the system increases the fuel flow demand to increase torque applied to the turbine output shaft and thereby maintains a speed of the output shaft within a given range.

### SUMMARY

In some embodiments, a method for controlling a turbine engine generator set is disclosed. The method comprises: sensing an operating parameter indicative of a load increase on the turbine engine generator set; operating the turbine engine generator set in a first mode when the sensed operating parameter is within a predetermined range; and operating the turbine engine generator set in a second mode when the sensed operating parameter is outside the predetermined range. The second mode provides a rate of adjustment of operation of the turbine engine generator set that is greater than a rate of adjustment during the first mode.

In some alternative embodiments, a system for controlling a turbine engine generator set is disclosed. The system comprises one or more sensors configured to sense an operating parameter indicative of a load increase on the turbine engine generator set. The system further comprises a controller configured to operate the turbine engine generator set in a first mode when the sensed operating parameter is within a predetermined range and to operate the turbine engine generator set in a second mode when the sensed operating parameter is outside the predetermined range. The second mode provides a rate of adjustment of operation of the turbine engine generator set that is greater than a rate of adjustment during the first mode.

### BRIEF DESCRIPTION OF THE DRAWINGS

FIG. 1 is an illustration of an exemplary disclosed control system for controlling a gas turbine engine generator set; and

FIG. 2 illustrates an exemplary process for controlling a gas turbine engine generator set.

### DETAILED DESCRIPTION

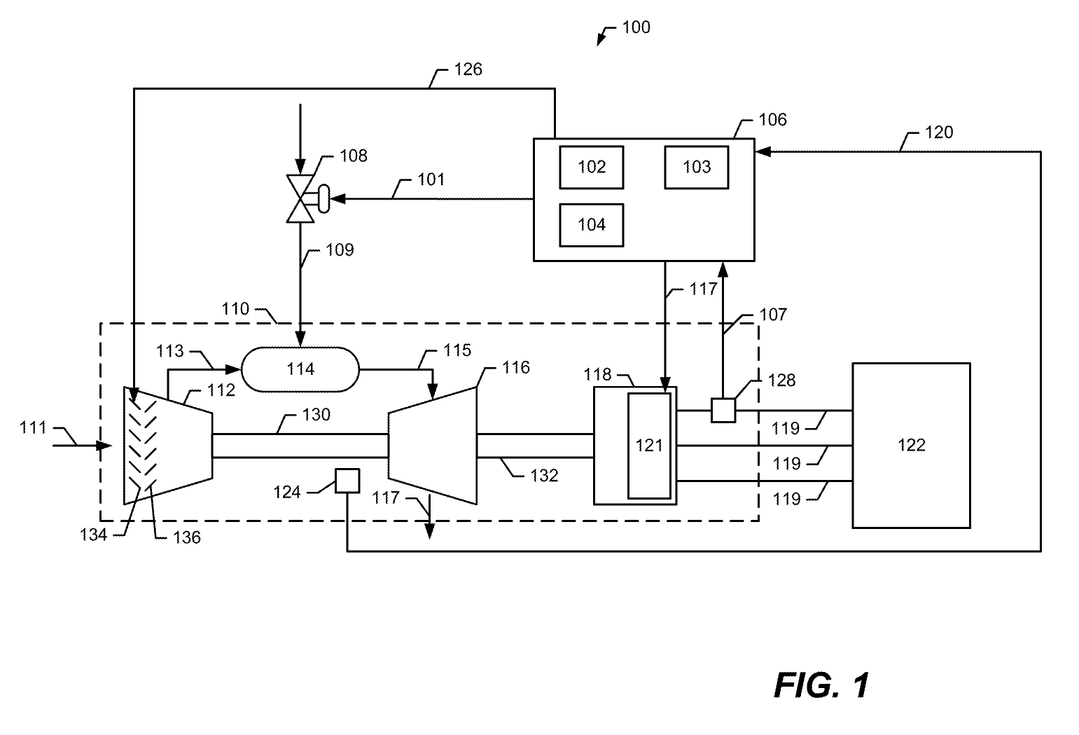

FIG. 1 illustrates an exemplary disclosed control system 100 for controlling a gas turbine engine generator set 110, in accordance with one embodiment.

In particular, gas turbine engine generator set 110 includes a compressor 112, a combustor 114, a turbine 116, and an electrical generator 118. Compressor 112 receives an incoming gas flow 111, compresses the gas to increase the pressure and temperature thereof, and provides the compressed gas to the combustor 114. Combustor 114, also known as combustion chamber or burner, receives the compressed gas flow 113 from compressor 112, and also receives fuel 109 through a fuel supply valve 108. Combustor 114 mixes the fuel and the compressed gas and heats the compressed gas by burning the fuel therein. The burning of the fuel adds energy to the compressed gas and increases the temperature of the gas flow. Combustor 114 then provides the higher temperature gas flow 115 to turbine 116. Higher temperature gas flow 115 drives turbine 116 and exits turbine system 110 as a lower-temperature, lower-pressure gas flow 117. Turbine 116 is coupled with compressor 112 through a compressor shaft 130. When driven by gas flow 115, turbine 116 rotates and drives compressor 112 through shaft 130. Turbine 116 is further coupled to generator 118 and drives generator 118 through an output shaft 132.

Compressor 112 may be an axial compressor including a plurality of stages. Each stage includes rotational blades or airfoils 136 driven by shaft 130, and stationary vanes 134 mounted on a compressor casing. The stationary vanes 134 guide the incoming gas flow onto the blades 136, while shaft 130 drives the rotational blades to move the gas in an axial direction to a next stage where the gas is further compressed. Compressor 112 may include a set of inlet guide vanes 134 mounted on the compressor casing in front of the first stage of compressor 112. Inlet guide vanes 134 direct incoming gas flow 111 onto a set of first-stage blades 136. First-stage blades 136 are driven by shaft 130 and move incoming gas flow 111 to the subsequent stages.

Each inlet guide vane 134 is mounted on a rotational shaft and may be rotated as desired. By positioning inlet guide vanes 134 at different angles, incoming gas flow 111 may be directed in different directions onto rotational blades 136 of the first stage of compressor 112, thereby controlling operational characteristics of turbine engine generator set 110, such as the rotational speed of shaft 130 and the output power of generator 118.

Generator 118 may be a DC generator or an AC generator known in the art. The output terminal of generator 118 is coupled to an electrical equipment 122 through output lines 119 so that generator 118 provides electrical power to drive equipment 122 or any other types of devices or systems configured to receive electrical power. Electrical equipment 122 may be a motor, a power mill, a heat pump, an electrical compressor, etc. Electrical equipment 122 draws electrical power from generator 118, thereby imposing electrical loads thereon. As a result, an electrical current flows in output lines 119 between generator 118 and electrical equipment 122, corresponding to the electrical loads provided to equipment 122. In general, the greater the electrical load drawn from generator 118, the greater the electrical current in output lines 119

According to a further embodiment, gas turbine engine generator set 110 is an integrated system, which is provided to a customer for producing electrical power. Compressor 112, combustor 114, turbine 116, and generator 118 may be assembled within an integrated package and coupled to electrical equipment 122. As such, generator set 110 provides a simple and integrated electrical power source, which enhances reliability and reduces maintenance costs.

Control system 100 includes a controller 106 for monitoring operational states and controlling operation of turbine engine generator set 110. For example, controller 106 may monitor status parameters, such as the output power of generator set 110, the rotational speed of shaft 130, or any other parameters necessary to control the generator set 110. Based on the status parameters, controller 106 may set control parameters, such as the fuel supply rate, the inlet guide vane angle, or the output voltage level. Alternatively, controller 106 may provide warning or shut down generator set 110 if the operational temperature exceed a threshold temperature value.

Control system 100 further includes a speed sensor 124 and a power sensor 128 configured to provide input signals to controller 106. The input signal may reflect the rotational speed of shaft 130 and the electrical load drawn by equipment 122, respectively. Based on the input signals, controller 106 determines a proper fuel supply rate, an output voltage level, and an inlet guide vane angle, and generates control signals 101, 117, and 126 to set the fuel supply rate, the output voltage level, and the inlet guide vane angle, respectively. In general, when the electrical load increases, controller 106 tends to increases the fuel supply rate and the inlet guide vane angle.

Sensor 124 is a speed sensor for measuring the rotational speeds of compressor shaft 130. Alternatively, sensor 124 may be associated with output shaft 132 to measure the rotational speed thereof. Sensor 124 may be a magnetic sensor or a hall effect sensor known in the art. Sensor 124 converts the rotations of shaft 130 into an electronic signal 120 and transmits the signal to controller 106. Controller 106 may then determine the rotational speed of shaft 130 according to signal 120.

Sensor 128 is an electrical power sensor configured to determine the output electrical power provided by generator 118 through the output terminals thereof. Power sensor 128 may be a DC or AC load sensor, which generates a signal 107 reflecting the electrical power provided to electrical equipment 122. For example, the power sensor 128 may determine the electrical power based on the voltage and current in output lines 119.

Controller 106 may include a fuel control module 102, a voltage control module 103, and a guide vane control module 104 to provide the control functions described herein. Control modules 102-104 may be implemented on one or more circuit modules, such as a programmable logic controller, a programmable gate array, an application specific integrated circuit, etc. Alternatively, control modules 102-104 may be implemented as software modules on a general-purpose computer. The computer includes suitable interfaces for receiving input signals from sensors 124 and 128 and transmitting control signals 101, 117, and 126. The software program associated with control modules 102-104 may be stored in a computer-readable medium as program codes. Upon being executed by the computer, control modules 102-104 may instruct the computer to control generator set 110 through control signals 101, 117, and 126.

According to an alternative embodiment, gas turbine engine generator set 110 may include a two-shaft turbine system. Specifically, turbine 116 may include a first turbine coupled to compressor 112 through compressor shaft 130 and a second turbine coupled to generator 118 through output shaft 132. The first turbine provides high-temperature gas flow 115 to the second turbine, thereby driving the second turbine to rotate, which then drives generator 118 through output shaft 132. According to this embodiment, shafts 130 and 132 may rotate at different speeds. Speed sensor 124 may be associated with either shaft 130 or 132 to measure the rotational speed, and controller 106 may perform the control functions described herein based on the rotational speed of either shaft 130 or 132.

Controller 106 receives input signals from sensors 124 and 128, determines the control parameters, and generates control signals 101, 117, and 126 based on control cycles. A control cycle of controller 106 includes a recursive sequence of control steps performed within a time interval according to the control logic. For example, in each control cycle, controller 106 samples the rotational speed and the output power reflected in the input signals, and compares the sample values with those from a preceding cycle. Controller 106 may adjust the fuel supply rate, the output voltage level, or the inlet guide vane angle for the current control cycle in accordance with the comparison results. Controller 106 may perform all or part of the control steps in each control cycle according to the control logic. Each control cycle may last for, for example, about 20 milliseconds. The length of the control cycle may vary depending on the configuration of controller 106. Further, the preceding control cycle may be immediately prior to the current control cycle or any other earlier control cycles.

Controller 106 may instruct generator set 110 to operate in a plurality of modes and switch generator set 110 between different modes in accordance with the status parameters reflected in the input signals from sensors 124 and 128. For example, controller 106 may set generator set 110 in a first mode (or a normal operating model), in which generator set 110 operates in a steady state. In the normal operating mode, controller 106 adjusts the parameters, such as the fuel supply rate, the output voltage level, and the inlet guide vane angle, continuously or in a very small increment in each control cycle. For example, when detecting an increases in the electrical load at the output of generator set 110 in a given control cycle, controller 106 may gradually increase the fuel supply rate by, for example, 1-2% from the preceding cycle. Alternatively, controller 106 may gradually decreases the output voltage level by, for example, 1-2% from the preceding cycle, in response to the increases in output load. Still alternatively, controller 106 may gradually increase the inlet guide vane angle at a rate equal to, for example, 1-2 degrees per second in response to the increases in the electrical load.

Under certain conditions, controller 106 may switch generator set 110 from the first mode to a second mode (or a transient mode), in which generator set 110 responds to the increases in the electrical load much more rapidly. For example, in a given control cycle, when detecting that there is a abrupt increase in the electrical load at the output of generator set 110 compared with a preceding control cycle, controller 106 may switch generator set 110 to the transient mode. Here, an abrupt increase in the electrical load or an abrupt load increase refers to an increase by 25-50% of the total capacity of the generator set 110 compared with the electrical load in the preceding control cycle.

In particular, in response to the abrupt load increase, controller 106 may increase the fuel supply rate by, for example, 5-15% from the preceding control cycle. Alternatively, controller 106 may decrease the output voltage level by, for example, 5-15% from the preceding cycle. Still alternatively, in the transient mode, controller 106 may increase the inlet guide vane angle to a fully open position at a rate of, for example, 25° per second. By switching generator set 110 from the normal operating mode to the transient mode, controller 106 allows generator set 110 to respond to the abrupt increase in the electrical load without comprising the performance of the system.

### INDUSTRIAL APPLICABILITY

The above-disclosed control system, while being described for use in a gas turbine engine generator set, can be used generally in alternative applications and environments, for example, where an abrupt increase in load is detected on the output of a generator. In general, the control system may respond to the increase in load by switching the generator set from the first mode to the second mode. The generator set operating in the second mode provides a rate of adjustment of the operation greater than a rate of adjustment in the first mode.

Referring back to FIG. 1, the electrical power consumed by electrical equipment 122 may vary, thereby causing the electrical load at the output terminal of generator set 110 to increase or decrease. For example, electrical equipment 122 may be an electrical motor driving a conveyor belt. The electrical load imparted onto generator set 110 may increase or decrease when the weight loaded onto the conveyor belt varies. As another example, electrical equipment 122 may include electrical systems in an industrial site, such as the lighting system, the air conditioning system, the sewage system, etc. As such, the electrical power demanded from generator set 110 may increase or decrease when the usage of the electrical systems varies, such as more light bulbs being turned on or the air condition being turned up. Depending on the changes in the electrical load, control system 100 sets generator set 110 in the normal operating mode or the transient mode and switches generator set 110 between different modes as described herein.

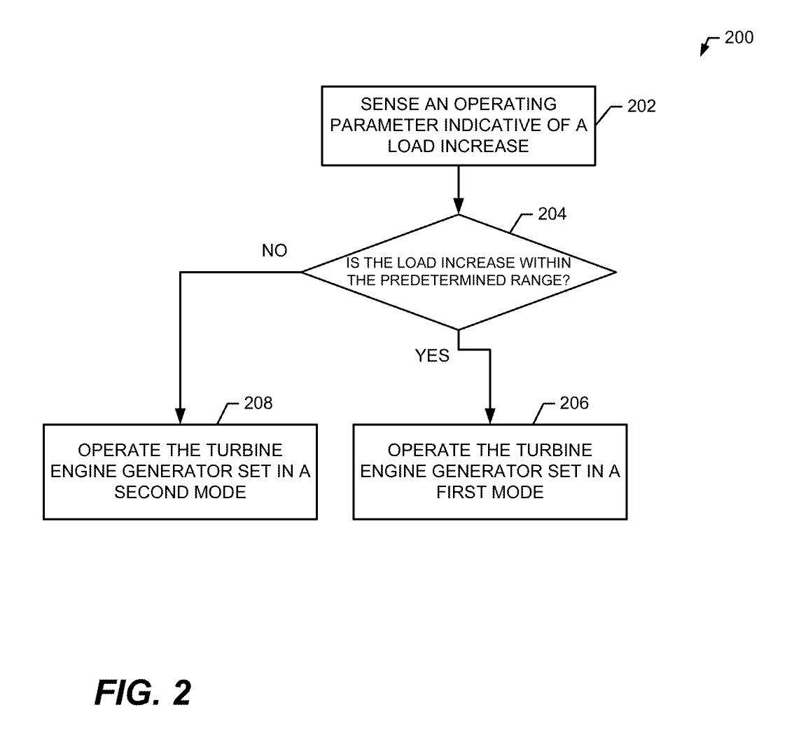

FIG. 2 depicts an exemplary disclosed process 200 for controlling turbine engine generator set 110 when a load increase is detected. Process 200 may be implemented on control system 100 through controller 106 and modules 102-104 included therein.

According to process 200, at step 202, control system 100 senses an operating parameters indicative of a load increase. As discussed above, control system 100 may perform the control functions based on control cycles and sample the input signals, including the rotational speed and the electrical load, in each control cycle. Based on the input signals (107,120), control system 100 adjusts the control parameters, if necessary, in each control cycle.

Further, at step 202, control system 100 determines whether a load increase is detected based on the operating parameters collected at each control cycle. According to some embodiments, control system 100 may detect the load increase through signal 107 from load sensor 128. Load sensor 128 transmits load signal 107 to controller 106, which reflects the electrical load or power drawn from generator set 110 through output lines 119 in the current control cycle.

Alternatively or additionally, controller 106 may detect the load increase based on the speed signals from speed sensor 124. Specifically, controller 106 samples speed signal 120 from sensor 124 in each control cycle and compares the speed signal in the current cycle with a speed signal received in the preceding cycle.

Controller 106 may also detect the load increase according to a fuel command that controller 106 generates as part of the control scheme in the normal operating mode. Specifically, when a load increase occurs, controller 106, in the normal operating mode, may attempt to respond to the load increase and thus generate a fuel command to instruct fuel valve 108 to increase the fuel supply rate. Thus, by checking the fuel command, controller 106 may detect whether a load increase has occurred at the output of generator set 110.

At step 204, control system 100 may determine whether the detected load increase is within the predetermined range. For example, controller 106 may compare load signal 107 collected in the current control cycle with load signals received in a preceding cycle. If a difference between the electrical load reflected by load signal 107 and the electrical load in the preceding cycle exceeds a threshold load value, controller 106 determines that an abrupt load increase has been added to the output of generator set 110 or that the load increase exceeds the predetermine range. In other words, controller 106 determines that an increase in electrical load at the output of generator set 110 corresponds to an abrupt load increase if the load increase between the current control cycle and the preceding control cycle exceeds the threshold load value. For example, the threshold load value may be 25-50% of the total capacity of generator set 110.

Alternatively or additionally, if the speed in the current cycle is lower than the speed in the proceeding cycle by at least a threshold speed value, controller 106 may determine that an abrupt load increase has occurred at the output of generator set 110 or that the load increase exceeds the predetermined range. According to a further embodiment, the threshold speed value may be set between 0.1% and 0.3% of the rotational speed in the preceding cycle. In other words, controller 106 may determine that an abrupt load increase has occurred if the rotational speed of generator set 110 decreases by a value greater than the threshold speed value.

Still alternatively or additionally, control system 100 may also check the fuel command to determine if the load increase exceeds the predetermined range. As discussed above, in the normal operating mode, the adjustment of the fuel supply rate by controller 106 is generally continuous or in very small increments. If controller 106 attempts to increase the fuel supply to counter the effects of an abrupt load increase, the fuel command in the current control cycle may include an instruction to increase the fuel supply rate by 1-2% from the previous control cycle. Based on such fuel command from controller 106, system 100 may determine that an abrupt load increase has occurred at the output of generator set 110 or that the load increase exceeds the predetermined range.

If control system 100 determines that the load increase sensed at step 202 is within the predetermined range, it may set generator set 110 in the normal operating mode (i.e., the first mode) as discussed above, so that generator set 110 gradually responds to the changes in the electrical load (step 206). In the normal operating mode, system 100 may vary the control parameters, such as the fuel supply rate, the output voltage level, and the inlet guide vane angle, in small increments so that generator set 110 gradually adapts to the change in the electrical load.

If, on the other hand, control system 100 determines that the load increase sensed at step 202 exceeds the predetermined range, it sets generator set 110 in the transient mode, i.e., the second mode (step 208). In general, generator set 110 operating in the second mode provides a rate of adjustment of the control parameters greater than the rate of adjustment during the first mode. Specifically, when an abrupt load increase is detected, system 100 may set generator set 110 to the second mode and may determine a step increase for the fuel supply rate. For example, if the electrical load of generator 118 increases by 25-50% of the capacity of generator set 110, fuel control module 102 may determine that the fuel supply rate must be step increased by 5-15% from the preceding cycle. Alternatively, if the rotational speed of shaft 130 decreases by 0.1-0.3% from the preceding control cycle, fuel control module 102 may also determine that the fuel supply rate must be step increased by 5-15%. Still alternatively, if controller 106 generates a fuel command in the current control cycle to instruct fuel valve 108 to increase the fuel supply rate by 1-2%, fuel control module 102 may then modify the fuel command to include an instruction for an additional 5-15% step increase in the fuel supply rate.

Additionally or alternatively, control system 100 operating in the second mode may determine a step decrease for the output voltage level in response to the detected abrupt load increase. For example, if the electrical load on output lines 119 increases by 25-50% of the capacity of generator set 110, voltage control module 103 may determine that the output voltage level must be step decreased by 5-15% to counter the abrupt load increase. Alternatively, if the rotational speed of shaft 130 decreases by 0.1-0.3% from the preceding control cycle, voltage control module 103 may also determine that the output voltage level must be step decreased by 5-15%. Still alternatively, if controller 106 generates a fuel command to instruct fuel valve 108 to increases the fuel supply rate by 1-2%, voltage control module 104 may then determine that the output voltage level must be step decreased by 5-15%.

Still additionally or alternatively, control system 100 may set the generator set 110 to the second mode and determine a step increase for the inlet guide vane angle in response to the detected abrupt load increase. Specifically, when system 100 detects an abrupt load increase as described above, inlet guide vane module 104 may signal to open the inlet guide vane from the current position to the fully open position within one second. According to a further embodiment, inlet guide vane module 104 may determine a rate for the inlet guide vanes equal to, for example, 50% of a full stroke angle per second. For instance, if the full stroke angle of the inlet guide vanes is 50° from fully closed to fully open, the rate set by inlet guide vane module 104 in response to the abrupt load increase is 25° per second. The full stroke angle of the inlet guide vanes may vary, depending on the configuration of generator set 110. In addition, inlet guide vane module 104 may set the rate for the inlet guide vanes at other values greater or less than 50% of the full stroke angle per second. In general, the greater the rate, the faster the inlet guide vanes reach the fully open position in response to the abrupt load increase.

Further at step 208, fuel control module 102 may generate and transmit fuel control signal 101 to fuel valve 108, including the instruction for step increasing the fuel supply rate. The step increase in fuel supply rate provides generator set 110 with additional energy to satisfy the abrupt load increase and to maintain the rotational speed of generator set 110.

Alternatively, voltage control module 103 may generate and transmit voltage control signal 117 to voltage regulator 121, including the instruction for step decreasing the output voltage level on lines 119. The decreased output voltage level effectively reduces the electrical load drawn from generator set 110 and maintains the rotational speed of generator set 110.

Still alternatively, inlet guide vane module 104 may generate and transmit inlet guide vane signal 126 to inlet guide vanes 134 and to increase the inlet guide vane angle according to the incremental rate or angle value determined at step 210. The step increase in the inlet guide vane angle increases incoming air flow 111, which allows generator set 110 to generate extra power output to satisfy the abrupt load increase. In general, inlet guide vane module 104 instructs the inlet guide vanes to reach the fully open position in less than one second in response to the detection of the abrupt load increase.

According to a further embodiment, system 100 operating in the second mode may selectively perform one or more of the above adjustments in each control cycle. For example, if electrical equipment 122 is voltage sensitive and requires the output voltage remain at a given level during its operation, system 100 may omit the voltage adjustment, so that the output voltage level may be maintained, while adjusting the fuel supply rate and/or the inlet guide vane angle to satisfy the abrupt load increase.

Still alternatively, the abrupt load increase caused by electrical equipment 122 may be in the form of discontinuous pulses. As a result, increasing the fuel supply rate may deteriorate system stability. Thus, system 100 may omit the fuel adjustment or limit the increase in the fuel supply rate, while adjusting the voltage output level and/or the inlet guide vane angle in response to the abrupt load increase. Other combinations of the adjustments may also be performed by system 100 as recognized by one skilled in the art.

According to still another embodiment, the inlet guide vane adjustment may be performed in every control cycle when an abrupt load increase is detected, so that the inlet guide vane angle is set to the fully open position whenever there is an abrupt load increase.

Here, the terms “step increase” and “step decrease” each refer to an instantaneous transition or change. It will be apparent to those skilled in the art that various modifications and variations can be made to the disclosed systems. Others embodiments will be apparent to those skilled in the art from consideration of the specification and practice of the disclosed systems. It is intended that the specification and examples be considered as exemplary only, with a true scope being indicated by the following claims and their equivalents.

What is claimed is:

1. A method for controlling a turbine engine generator set, comprising:
sensing an operating parameter indicative of a load increase on the turbine engine generator set;
operating the turbine engine generator set in a first mode when the sensed operating parameter is within a predetermined range; and
operating the turbine engine generator set in a second mode when the sensed operating parameter is outside the predetermined range,
wherein the second mode provides a rate of adjustment of operation of the turbine engine generator set that is greater than a rate of adjustment during the first mode.

2. The method of claim 1, wherein the sensed operating parameter includes at least one of a rotational speed of a compressor shaft, an output power of the turbine engine generator set, or a fuel supply rate generated by a controller of the turbine engine generator set.

3. The method of claim 2, further comprising receiving a speed signal from a speed sensor indicative of the rotational speed of the compressor shaft.

4. The method of claim 3, wherein operating the turbine engine generator set in the first mode further comprises determining, based on the speed signal, a decrease of the rotational speed is below a threshold speed value.

5. The method of claim 4, wherein operating the turbine engine generator set in the second mode further comprises determining, based on the speed signals, the decrease of the rotational speed is greater than the threshold speed value.

6. The method of claim 5, wherein the threshold speed value is set between 0.1% and 0.3% of the rotational speed in a preceding control cycle.

7. The method of claim 2, further comprising receiving a power signal from a load sensor indicative the output power of the turbine engine generator set.

8. The method of claim 7, wherein operating the turbine engine generator set in the first mode further comprises determining, based on the power signal, that an increase of the output power is below a threshold load value.

9. The method of claim 8, wherein operating the turbine engine generator set in the second mode further comprises determining, based on the power signal, that an increase of the output power is greater than the threshold load value.

10. The method of claim 9, wherein the threshold load value is between 25% and 50% of a capacity of the turbine engine generator set.

11. The method of claim 2, further comprising:
receiving a fuel command from the controller; and
determining that the fuel command includes an instruction for increasing the fuel supply rate by a predetermined value.

12. The method of claim 11, wherein the predetermined value is between 1% and 2% of the fuel supply rate in a preceding control cycle.

13. The method of claim 1, wherein the rate of adjustment of the operation of the turbine engine generator set during the second mode includes at least one of a 5-15% increase of the fuel supply rate per control cycle or a 5-15% decrease of the output voltage per control cycle.

14. The method of claim 1, wherein the adjustment of the operation of the turbine engine generator set during the second mode further comprises setting an inlet guide vane angle of the turbine engine generator set to a fully open position in less than one second.

15. A system for controlling a turbine engine generator set, comprising:
one or more sensors configured to sense an operating parameter indicative of a load increase on the turbine engine generator set; and
a controller configured to:
operate the turbine engine generator set in a first mode when the sensed operating parameter is within a predetermined range; and
operate the turbine engine generator set in a second mode when the sensed operating parameter is outside the predetermined range,
wherein the second mode provides a rate of adjustment of operation of the turbine engine generator set that is greater than a rate of adjustment during the first mode.

16. The system of claim 15, wherein the operating parameter includes at least one of a rotational speed of a compressor shaft, an output power of the turbine engine generator set, or a fuel supply rate generated by the controller.

17. The system of claim 15, wherein the adjustment of operation of the turbine engine generator set includes an adjustment of at least one of a fuel supply rate, an output voltage level, and an inlet guide vane angle.

18. The system of claim 17, wherein the controller is further configured to increase or decrease the fuel supply rate by 5-15% per control cycle in the second mode.

19. The system of claim 17, wherein the controller is further configured to:
generate a fuel command in response to the load increase during the first mode, the fuel command including an instruction to increase the fuel supply rate by 1-2% per control cycle; and
include an additional instruction in the fuel command to increase the fuel supply rate by an additional 5-15% per control cycle in the second mode.

20. A turbine engine generator set for generating electric power, comprising:
a power turbine configured to generate rotational power;
a generator coupled to the power turbine, the generator converting the rotational power to electric power;
one or more sensors configured to sense an operating parameter indicative of a load increase of the power turbine generator set; and
a controller configured to:
operate the turbine engine generator set in a first mode when the sensed operating parameter is within a predetermined range; and
operate the turbine engine generator set in a second mode when the sensed operating parameter is outside the predetermined range,
wherein the second mode provides a rate of adjustment of operation of the turbine engine generator set that is greater than a rate of adjustment during the first mode.
